(19) United States
(12) Patent Application Publication
(10) Pub. No.: US 2021/0271983 A1
(43) Pub. Date: Sep. 2, 2021

(54) MACHINE INTELLIGENCE FOR RESEARCH AND ANALYTICS (MIRA) SYSTEM AND METHOD

(71) Applicant: LYMBYC SOLUTIONS PRIVATE LIMITED, Bangalore, Kamataka (IN)

(72) Inventors: Satyakam MOHANTY, Bangalore (IN); Ashish RISHI, Bangalore (IN); Pradeepta MISHRA, Bangalore (IN)

(73) Assignee: LYMBYC SOLUTIONS PRIVATE LIMITED, Bangalore, Karnataka (IN)

(21) Appl. No.: 17/258,613

(22) PCT Filed: Jul. 9, 2019
(86) PCT No.: PCT/IN2019/000017

§ 371 Date: Jan. 7, 2021

(30) Foreign Application Priority Data
Jul. 10, 2018 (IN) 201841025668

(51) Int. Cl. G06N 5/02; G06F 16/242; G06F 16/2452; G06F 16/2457; G06F 16/26; G06F 40/284; G06N 20/00

(52) U.S. Cl. CPC G06N 5/025; G06N 5/022; G06F 16/2425; G06F 16/243; G06N 20/00; G06F 16/24573; G06F 16/26; G06F 40/284; G06F 16/24522

(57) ABSTRACT

A Machine Intelligence for Research and Analytics (MIRA) system and method for processing and retrieving relevant business insights with respect to a natural language-based query of a business user. The MIRA system comprises an encoder component wherein the first intermediate query language (IQL1) is an output of a NLP server engine of the MIRA system. A decoder component which involves second intermediate query language (IQL2), a reduced form of IQL1 obtained by displaying the IQL1 to the business user (in an interface) for additional user preferences and options by changing the elements of IQL 1 to obtain IQL2 as a direct interpretation (queried/aggregated) of the business user to the MIRA system.

### TECHNICAL FIELD

Embodiments are generally related to the field of query processing systems and methods. Embodiments are further related to natural language processing, deep learning, machine learning and artificial intelligence-based systems and methods. Embodiments are particularly related to a novel systems and methods for providing natural language-based interface for business information/insights retrieval for businesses. Embodiments are more particularly related to Machine Intelligence for Research and Analytics (MIRA) system and method for processing and retrieving relevant business insights with respect to a natural language-based query of a user.

### BACKGROUND OF THE INVENTION

Majority of businesses use a wide range of analytics and insights in their business decision making processes. Conventionally, such decision-making processes (involving analyst teams) receive a business question (typically a natural language-based query) either through an email or through a briefing and these teams use tools to retrieve the data and provide data led insights through a presentation or dashboard that can help the business user in taking an informed decision. The business questions are, in general, a natural language-based query from a business user which require either a basic summarization of data, calculation of company specific KPIs or also involve application of advanced algorithms (e.g. Forecasting, segmentation)

Conventionally, systems and methods for processing such queries require human intervention (such as large team of analysts) to undertake the analysis and provide required inputs with respect to the queries of the business users. Conventional analyst teams use scripting languages such as Java, VBA etc. to automate such user requirements where the programmatic interventions are specific to certain scenarios and the analyst team intervention is required when a new scenario is occurred in the system.

Most of the businesses employ a question and answer (Q&A) agent/system for processing the businesses queries and providing insights to the business users. Such prior art Q&A systems are not compatible for most of the business applications. Such prior art systems are unable to handle business queries effectively as they were unable to effectively convert the natural language query into a machine understandable language. Furthermore, such prior art systems are unable to handle and execute complex algorithms and poor decision points.

Majority of prior art systems and methods were introduced to address these short comings by focusing on addressing the process of insight generation by developing a natural language-based interface that can understand a business question. For example, U.S. Pat. No. 9,223,776 disclose a multimodal natural language query system for processing and analysing voice and proximity-based queries. This application proposes use of an annotation tool to support information retrieval of business information. Similarly, US 2017/0075988 disclose a method and system for automatic resolution of user queries where the queries are identified based on entity recognition (domain specific or generic) and provide responses to the business queries. Such prior art systems and methods are unable to provide a machine learning driven query conversion engine that provides business insights support to the businesses by focusing on addressing the process of insight generation by developing an natural language based interface that can understand a business question, leverage machine learning in building context required to address the business need, have the ability to invoke advanced algorithms and undertake decisions or make suggestions to the business user.

Based on the foregoing a need therefore exists for an improved system and method for converting a business user provided natural language query into a database query and use the query for information retrieval which is not directly available in the database, apply necessary actions to derive insights if required, which can be achieved by an aggregate query, or a formula based retrieval (KPIs), or an algorithm based retrieval or a ML/DL model based retrieval or a hybrid multi-step retrieval (like a composite model scenario which has a transformation step and algorithm step) and represent it through a visual processing engine. A need exists for an improved Machine Intelligence for Research and Analytics (MIRA) system and method for processing and retrieving relevant business insights with respect to a natural language-based query of a user, as described in greater detail herein.

### SUMMARY OF THE INVENTION

The following summary is provided to facilitate an understanding of some of the innovative features unique to the disclosed embodiment and is not intended to be a full description. A full appreciation of the various aspects of the embodiments disclosed herein can be gained by considering the entire specification, claims, drawings, and abstract.

Therefore, one aspect of the disclosed embodiment is to provide for an improved system and method for receiving, processing and providing relevant business insights with respect to a natural language-based query of a business user.

Another aspect of the disclosed embodiment is to provide for an improved system and method for converting a business user provided natural language query into a database query and use the query for information retrieval which is not directly available in the database.

Further aspect of the disclosed embodiment is to provide for an improved Machine Intelligence for Research and Analytics (MIRA) system and method for processing and retrieving relevant business insights with respect to a natural language-based query of a user.

The aforementioned aspects and other objectives and advantages can now be achieved as described herein. A Machine Intelligence for Research and Analytics (MIRA) system and method for processing and retrieving relevant business insights information with respect to a natural language-based query of a business user, is disclosed herein. The MLRA system includes an encoder component of which the first output is intermediate query language (IQL1), wherein the first intermediate query language (IQL1) can be defined as an output of a NLP server engine of the MIRA system. A decoder component of which the second intermediate query language (IQL2) is an output, otherwise known as a reduced form of IQL1 obtained by displaying the IQL1 to the business user (in an interface) for additional user preferences and options by changing the elements of IQL1 to obtain IQL2 as a direct interpretation (queried/aggregated) of the business user to the MIRA system.

The MIRA system involves a labelled supervised model to predict the sub-domain we call it a sub set of data set where the answer might be present. The training data set is prepared by the domain expert who has knowledge about the data lake, data warehouse. From the pre-trained list of questions with their label, a supervise vector space model is trained in grid search mode to make correct predictions. This is a critical step, if the prediction is not right, then the tokens will not be parsed. Hence making correct predictions is dependent on the training data set as well as the learning process. The algorithm learns from the experiences continuously to make the predictions better, every time the user asks a question.

The MIRA system comprises an Knowledge Store that understands the user intent, an ontology layer that remembers/stores the database schema with additional properties as required by the Knowledge Store to understand the user's intent better, and a configuration file which is specific to the client terminology and domain specific entry. The ontology layer receives inputs from data bases for example, it can be a SQL database (MySQL/Oracle) or NoSQL data base (such as Data Store/Data Store). The data base schema defined to capture all the elements required for ontology is custom driven, as per the NLP engine requirement.

An NLP server engine acting as a main interface for parsing the user text, match named entities, phrases and matches rules from the Knowledge Store wherein the NLP server engine passes the relevant tokens and phrases to a search layer. The NLP engine refers to the named entity recognition frameworks and time reference frameworks available online as well as in custom in house data base to parse the tokens. One such example is Google NLP API and Stanford SU time reference open source library. The search engine upon receiving the relevant tokens or phrases from the NLP server engine, performs search where the database search layer acts as a search component for the MIRA application. The result fetched from the database search layer follows a data visualization rule engine, which involves application of rules to create appropriate graphs for the user. An algorithmic integration module for bridging the intervention from ML libraries (which currently acts upon a call from the application) with respect to the query (when the answering system requires an algorithm to be applied).

The encoder component of the MIRA system involves parsing the natural language and identifies the tokens, named entities, phrases, parts of speech tags. The encoder refers Ontology when there is an indirect reference to the tokens. The encoder further recognises data base properties such as, dimensions, measures, filters, actions, grouping, reporting requirements, display requirements etc. based on a set of rules (that are part of the Knowledge Store) and encoder generates final representation in the form of IQL1.

The decoder component of the MIRA system involves in summarization of responses with respect to the queries of the business user by displaying the responses from the database to the user in a meaningful way, so that the user can consume. The decoder uses different types of summarization based on the set of rules. For example, summarization based on count, averages, dot product operators etc. The decoder also involves in algorithmic intervention when certain queries require algorithmic intervention based a set of rules to decide on which algorithms to invoke and when and for which task.

### BRIEF DESCRIPTION OF FIGURES

The drawings shown here are for illustration purpose and the actual system will not be limited by the size, shape, and arrangement of components or number of components represented in the drawings.

The FIG. 0 explains the way the user will interact with the system. The user first enters a question in the interface, then the system predicts the sub set of data where the answer resides, the user selects, after that, the user gets to see the fields relevant to his/her search criteria, where a brief narrow down screen will appear, the user selects, to fine tune the search results. The selected fields will go through a search layer to find out relevant summarized output. The visualization engine will be referred to understand the needed graph to display the results. The output will be displayed to the user, and the user provides input such as whether the output is relevant or not.

FIG. 1 illustrates a high-level flow chart demonstrating the operations steps involved in the Machine Intelligence for Research and Analytics (MIRA) system for processing and retrieving relevant business insights with respect to a natural language-based query of a user, in accordance with the disclosed embodiments;

FIG. 2 illustrates a flow chart illustrating the operational steps involved in processing a query at MIRA system, in accordance with the disclosed embodiments; this figure has two components the encoder is the top box represented on the graph and the decoder component is the bottom box.

FIG. 3 illustrates a flow chat of operation illustrating the process steps of the encoder component of the MIRA system, in accordance with the disclosed embodiments;

FIG. 4 illustrates a process flow illustrating the classification of questions into different sub-domains at encoder level, in accordance with the disclosed embodiments; and

FIG. 5 illustrates a flow chart of operation illustrating the process steps of the decoder component of the MIRA system, in accordance with the disclosed embodiments.

FIG. 6 illustrates the re-inforcement layer, where the user feedback received by the system is used to make necessary amendments in the system, so that a better result is delivered next time to the user.

### DETAILED DESCRIPTION

The values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes all combinations of one or more of the associated listed items.

The terminology used herein is for describing embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

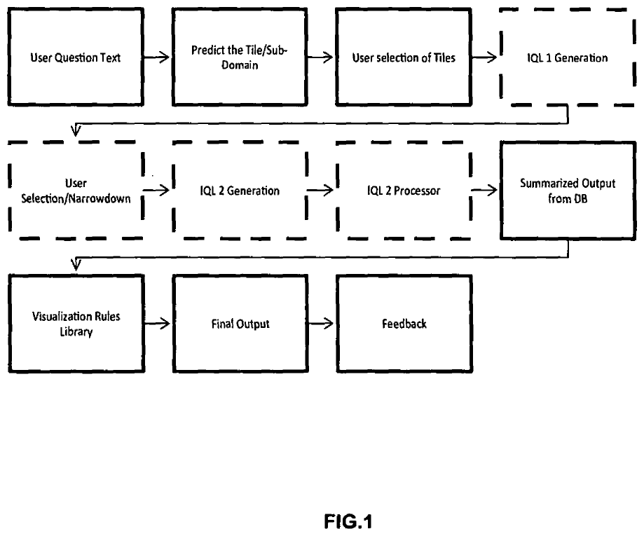

FIG. 1 illustrates a high-level flow chart 100 demonstrating the operations steps involved in the Machine Intelligence for Research and Analytics (MIRA) system for processing and retrieving relevant business insights with respect to a natural language-based query of a user, in accordance with the disclosed embodiments. The MIRA system includes an encoder component 140 wherein the first intermediate query language (IQL1) 140 can be an output of a NLP server engine of the MIRA system. The IQL1 140 is an output of the NLP pipeline that sits at the core of MIRA to provide information for further processing. Before the user question text 110 passes through the NLP engine, it must go through a predictive layer to understand the location/category where the answer lies. (For example: a pharma company might have 10 different data sets in their data base, this layer provides direction to a pointed search). This process is a sub-domain or tile or subset prediction, as disclosed at block 120 and 130.

The NLP component derives the entities from the Questions asked in the application. NLP Component internally uses the Natural Language Processing API to derive the entities. These entities are then combined along with the Metadata (loaded in the ontologies) of data present in the NLP database. The entities find references in the metadata and are reduced through a set of rules created through an Knowledge Store. Entities along with references on metadata are listed in respective sections of IQL1 140 which is used by the system.

A decoder component 160, obtained by displaying the IQL1 140 to the business user (in an interface) for additional user preferences and options by changing the elements of IQL1 140 (as illustrated at block 150) to obtain IQL2 160 as a direct interpretation (queried/aggregated) of the business user to the MIRA system.

The decoder component 160 of the MIRA system involves in summarization of responses with respect to the queries of the business user by displaying the responses from the database to the user in a meaningful way, so that the user can consume, as disclosed at block 170 and 180. The decoder uses different types of summarization based on the set of rules. For example, summarization based on count, averages, dot product operators etc. The decoder process also involves in algorithmic intervention when certain queries require algorithmic intervention based a set of rules to decide on which algorithms to invoke and when and for which task.

A data visualization layer/representation module which involves application of rules to create appropriate graphs for the user to create visualization and the matched summarized data will be rendered using the application, as disclosed at blocks 185-195.

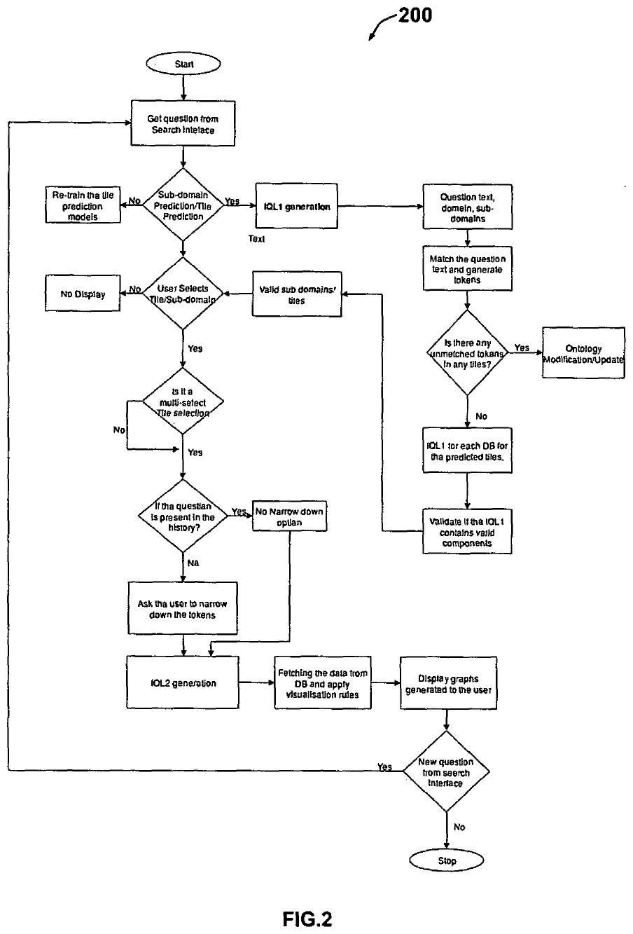

FIG. 2 illustrates a flow chart 200 illustrating the operational steps involved in processing a query at MIRA system, in accordance with the disclosed embodiments. The MIRA system comprises a database which is a central repository storing data uploaded by the business user and the links/URLs used by the business user. The database can be for example, but not limited to, a SQL database (MySQL/Oracle) or NoSQL data base (Data Store/Data Store). A NLP server engine acting as a main interface for parsing and rule-based matching wherein the NLP server engine passes the relevant tokens and phrases to a search layer. The search layer receives the relevant tokens or phrases from the NLP server engine and sends them to an Data Store interface where the Data Store layer acts as a search component for the MIRA system.

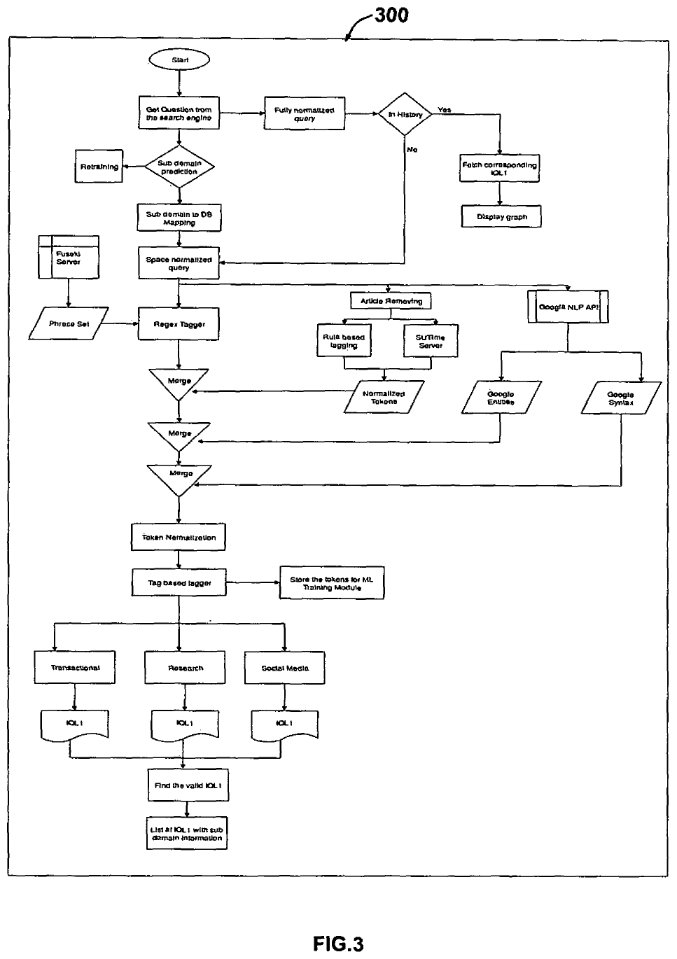

FIG. 3 illustrates a flow chat 300 of operation illustrating the process steps of the encoder component 140 of the MIRA system, in accordance with the disclosed embodiments. The encoder component 140 of the MIRA system involves parsing the natural language and identifies the tokens. The encoder 140 refers Ontology when there is an indirect reference to the tokens. The encoder 140 further recognises data base properties such as, dimensions, measures, filters, actions, grouping etc. based on a set of rules (that are part of the Knowledge Store) and encoder 140 generates final representation in the form of IQL1 140.

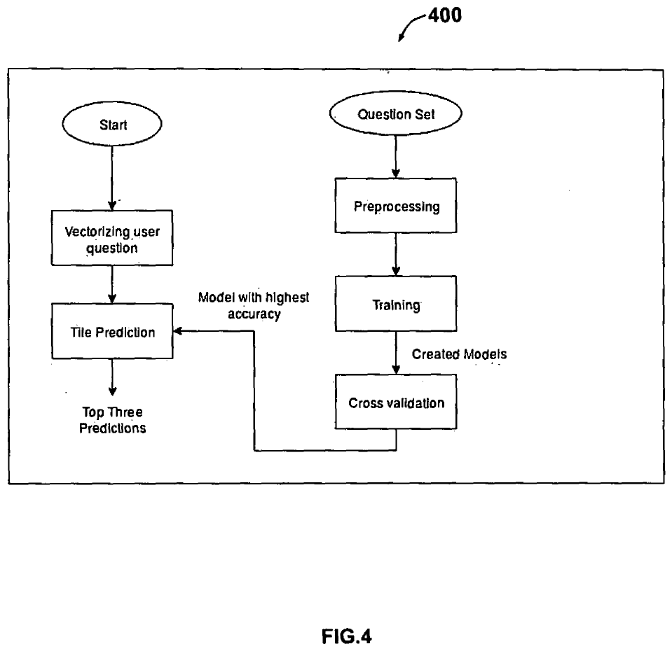

FIG. 4 illustrates a process flow 400 illustrating the classification of questions into different sub-domains at IQL1 140, in accordance with the disclosed embodiments. For example, in typical research study, there can be different metrics to be tracked on such as awareness, consideration, preference, purchase etc. each such metric has been associated with a predefined set of features. So, there is a need for developing a classifier that can fine tune the search criteria for NLP. The system uses an auto tuned/scaled, self-learning model, in grid search mode using a family of machine learning models. In case the underlying data set changes and some models fail to predict the correct class, then other set of models comes to the rescue, to provide classification correctly. Note that the encoder component 140 should be constituted any limited sense, the encoder component 140 can process the information in a different way for different types of data sets, such as for market research or survey dataset it will follow the research encoder module within the scope of the proposed invention.

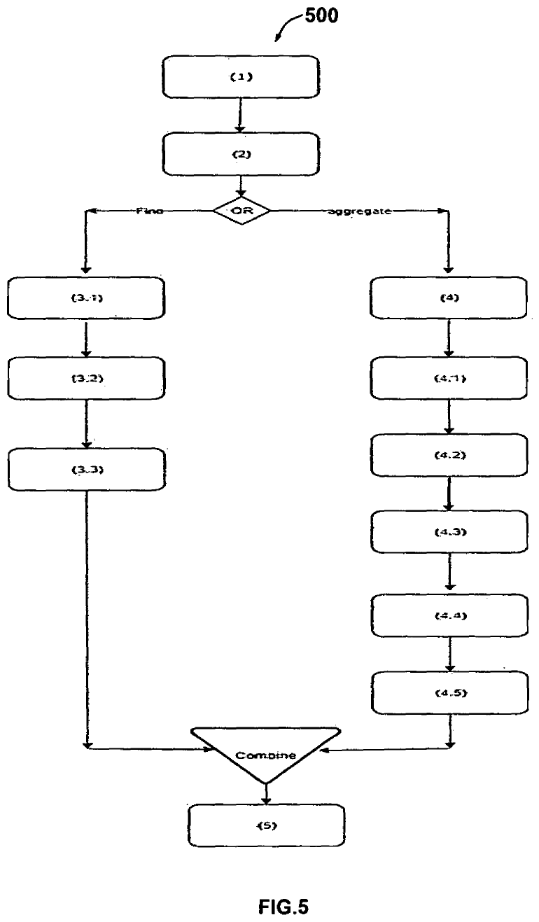

FIG. 5 illustrates a flow chart 500 of operation illustrating the process steps of the decoder component 160 of the MIRA system, in accordance with the disclosed embodiments. The decoder component 160 of the MIRA system involves in summarization of responses with respect to the queries of the business user by displaying the responses from the database to the user in a meaningful way, so that the user can consume. The decoder 160 uses different types of summarization based on the set of rules. For example, summarization based on count, averages, dot product operators etc. The decoder 160 also involves in algorithmic intervention when certain queries require algorithmic intervention based a set of rules to decide on which algorithms to invoke and when and for which task.

The IQL1 140 and IQL2 160 interaction and their internal processing are done differently for different types of data such as for transactional data, research data and other sources of data such as social data, geo data, as the meta data structure will change. They are based on type of process performed in the database to construct ontology store. At ontology store level the separation is made between different sources of data. Find type of query from decoder process will give the records present in the database where as the aggregation type will give the results on the types of aggregation such as average, sum, sum product etc. performed on the database.

Apart from the above two types of queries we can identify the following things from the query expressed in natural language: filter—it tells the system to reduce the dataset to set of records that satisfy the condition present within the section. Both query types respective operation is performed after the set conditions are applied to the dataset. Dimension (Dimension)—gives us the list of dimensions (typically the categorial columns, which is of string data type with all the unique levels appearing in it) along with its operations to be performed on the database. Measure (Measure)—gives us the list of measures (typically the continuous variables which is of integer and ratio data type) along with its options to be performed on the database. Group (Grouping)—list of dimensions from the dimension list that need to be used for aggregation on the dataset, applying operations on a dataset based on the conditions from another variable in the dataset. This will be used only when query type is aggregation. Action (Actions needed to be performed)—this helps the system run Machine learning model and algorithms on top of queried/aggregated data from the dataset.

The decoder 160 has both generation and processor module, it first generates a query in IQL2 160 format and then queries the database to retrieve summarized results. The IQL2 Processor, irrespective of the type of operation (find or aggregation) goes on to convert the filter section of IQL to Data Store DSL Query. This DSL Query is generated using recursion mechanism to support nested querying, as illustrated at block 1. IQL Processor then depending on the type of operation (find or aggregation) is handled accordingly, as illustrated at block (2). If query type is “Find”, the variables (fields in DB) are added to the source list by projecting in the output. If the source list is finally empty, then the entire source is projected in the output, as illustrated at block (3.1)

The “limit” is applied if the output needs to be limited from Data Store. If limit is not provided, then all the records are fetched from Data Store, as illustrated at block (3.2). The DSL query along with Source list and limit are applied as Data Store Querying input and the output is send as response back to the user, as depicted at block (3.3). If the query type is “Aggregation”, then aggregation part of Data Store is generated from dimension, measure and group section of IQL2, as illustrated at block (4). “Group” section is iterated in recursive manner to form terms aggregations (equivalent to grouping in SQL) in a nested manner. Group has variables in the order of list where each variable is a dimension, as illustrated at block 4.1. Once the last variable of group section is used, then date variables are iterated again in recursive manner to form nested aggregations (of histogram and range) and measure is also iterated to add to nested aggregation if it contains aggregations of type histogram and range, as depicted at block 4.2. Then the dimension and measure are iterated respectively to form stats aggregation (for operator such as count, average or sum) to get the output for measure and total document count of each bucket are used for dimension (for operator count), as illustrated at 4.3. The constructed aggregation is then combined with DSL query and passed to Data Store as input to get results, as shown at 4.4. The limit value is used finally to restrict the number of results in the output after we get the response from Data Store, as illustrated at 4.5. Output in case of either find or aggregation is sent back as response from IQL2 Processor, as illustrated at 5.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

We claim:

1. A Machine Intelligence for Research and Analytics (MIRA) system for processing a query expressed in natural language and retrieving relevant insights with respect to the query of a business user, said system comprising:
An encoder component translates the user query post subdomain prediction into intermediate query language (IQL1) wherein the first intermediate query language (IQL1) is an output of an NLP server engine of the MIRA system; and
a decoder component that understands the IQL1 and processes IQL1 and represent it in second intermediate query language (IQL2), a reduced form of IQL1 obtained by displaying the IQL1 to the business user (in an interface) for additional user preferences and options by changing the elements of IQL1 to obtain IQL2 as a direct interpretation (queried/aggregated) of the business user to the MIRA system.

2. The MIRA system of claim 1 further comprising an ontology store, where in three different types of ontology exists, domain specific, data base specific and generic. The data base specific ontology gets updated upon receiving the data base schema from the data base. Ontology is the central repository storing the metadata from data uploaded by the business user.

3. The MIRA system of claim 1 further comprising an NLP server engine acting as a main interface for recognizing named entities, parsing the query, understanding the parts of speech tags and rule-based matching by referring to the NER library. Then the NLP server engine passes the relevant tokens and phrases to a data extraction and processing layer.

4. The MIRA system of claim 1 further comprising a data extraction and processing layer for receiving the relevant tokens or phrases from the NLP server engine and send to a Data Store interface where the Data Store layer acts as a search component for the MIRA application.

5. The MIRA system of claim 1 further comprising an algorithmic integration module, the IQL1 will indicate if any algorithmic intervention would be required as per the user's intent, if yes, then built in ML algorithms from the library will be triggered.

6. The MIRA system of claim 1 wherein the encoder further recognises at least one of the following database properties: dimensions, measures, filters, actions, grouping based on a set of rules to generate final representation in the form of IQL 1.

7. The MIRA system of claim 1 wherein the decoder component involves in summarization of responses with respect to the queries of the business user by displaying the responses from the database to the user in a meaningful way wherein the decoder uses different types of summarization based on the set of rules.

8. The MIRA system of claim 1, involves decoder system, where a set of rules applied to understand the level of aggregation and type of aggregation that would be required as inferred from the IQL1. The level and type of aggregation will keep changing from different type of data structures.

9. The MIRA system of claim 1 further comprising a data visualization layer/representation module which involves application of rules to create appropriate graphs for the user to create visualization and the matched summarized data will be rendered using the application.
